(19) United States
(12) Patent Application Publication
(10) Pub. No.: US 2024/0117836 A1
(43) Pub. Date: Apr. 11, 2024

(54) CUT AND COMPRESSION DEVICE

(71) Applicant: Joseph Anthony Hauser, Williamsport, PA (US)

(72) Inventor: Joseph Anthony Hauser, Williamsport, PA (US)

(21) Appl. No.: 18/482,506

(22) Filed: Oct. 6, 2023

Related U.S. Application Data
(60) Provisional application No. 63/414,553, filed on Oct. 9, 2022.

(51) Int. Cl. F16B 43/00

(52) U.S. Cl. CPC F16B 43/001

(57) ABSTRACT

A cut and compression device is provided comprising at least one washer having at least one cutting edge and at least one compression surface wherein said washer has (a) a circular profile having a perimeter and wherein said washer has a center that is a void or a hole, and (b) wherein said cutting edge of said washer is located around or in juxtaposition to said perimeter of said washer, and wherein said compression surface is located downstream of said cutting edge.

### CROSS-REFERENCE TO RELATED APPLICATION

This utility non-provisional patent application claims the benefit of priority to U.S. Provisional Patent Application Ser. No. 63/414,553, filed Oct. 9, 2022. The entire contents of U.S. Provisional Patent Application Ser. No. 63/414,553 is incorporated by reference into this utility non-provisional patent application as if fully rewritten herein.

### STATEMENT REGARDING FEDERALLY SPONSORED RESEARCH OR DEVELOPMENT

Not applicable.

### BACKGROUND OF THE INVENTION

### 1. Field of the Invention

This invention provides a cut and compression device comprises of at least one washer The cut and compression device comprises a washer having at least one cutting edge and at least one compression surface wherein said washer has (a) a circular profile having a perimeter and wherein said washer has a center that is a void or a hole, and (b) wherein said cutting edge of said washer is located around or in juxtaposition to said perimeter of said washer, and wherein said compression surface is located downstream of said cutting edge. In certain embodiments of this invention, said washer has a receiving profile surface which is formed to match an optional hardware element. The hardware element may be for example but not limited to a fastener.

### 2. Description of the Background Art

There are many types of fasteners on the market today which are commonly used to secure materials such as wood. Of these fastener types, one of the most common is the flat head screw. When using the most basic form of this type of screw in wood applications, a user is often required to drill and countersink the wood prior to driving in the screw. Failure to pre-drill a simple flat head screw often causes the head to strip out and failure to countersink the surface prior to driving in the screw often causes the surface of the wood to split. The splitting of the wood around the head is due to the nature of the design of a flat head screw. Since the screw head is driven below the surface during installation, there is a need for the wood occupying the space that the head will take up after installation to be either removed via counter sinking or wedged out of the way by the screw head when driving in the screw without countersinking. When opting not to countersink however, the wedging action often causes splitting at the time of installation or later as the wood dries and moves.

In more recent years, several manufacturers have introduced screw designs which are self-drilling so the need to pre-drill wood prior to installation is eliminated. Some of these can be seen on the market today sold under names such as GRK, SPAX, and Hillman. Furthermore, to eliminate the need to countersink the wood prior to installing the screw, manufacturers such as these have added special features to the underside of their screw heads which are said to create a clean looking installation, without splits by removing or effectively displacing the wood under the head as the screw is driven into the wood. In other words, screws of this design are intended to be driven into wood in one step without the need to do any surface preparation such as pre-drilling or countersinking.

The possibility of installing a screw in a one-step operation is ideal however the screw designs currently available on the market today do have their drawbacks. When applied, the actual results can vary widely due to a variety of different reasons such as wood type, grain and moisture level. To explain, it is difficult to create a clean look around a screw head by using a spinning motion as is created when driving in a screw. Due to the common screw pitch and the speed that the head passes through the wood, it is difficult to cleanly cut the wood out of the way to make room for the head. If good results are achieved, they are often not reliably repeated and are less than ideal.

Another drawback of the common flat head screw is that it has a wedge shape which when it applies force to the contact surface of the wood, it naturally drives the wood away from the center axis of the screw. As the force exerted on the wood by the head of the screw is increased, it further increases sideways force on the wood as the surface under the head is wedged with greater force. During installation, if the screw is driven too deep in an attempt to pull the wood into position, the head is likely to pull through the wood until its head is past the surface which severely diminishes its holding potential. If kept near the surface, the screw head is likely to cause splitting around the head at a later time as the wood dries and moves. In essence, results achieved when using a common flat head screw, it is difficult to achieve ideal results even with current screw designs.

When wood is wet, as is the case when pressure treated wood is new, it is much more pliable which makes it increasingly difficult to draw into place using a common flat head construction screw. It is for this reason that the surface tension of the wood is drastically reduced as moisture level is increased. As a result, when a typical flat head screw is driven into wood with high moisture, the moisture often squeezes out as the hardware is tightened and as the head draws into the surface, the wood often mushrooms around the head and the screw head is then unable to draw the wood tight into position. This occurrence results in a weaker joint and an unsightly installation. Many users skilled in the art will find that regardless of the screw used, when fastening wet wood, countersinking is necessary to improve appearance; however, this step only helps to reduce splitting and does not have a significant effect on the surface tension. Furthermore, countersinking is a time-consuming task which adds significant time to the process when repeated screws are installed.

When selecting a wood screw, there are many different types on the market and each manufacturer claims theirs is the best. When a user meticulously considers the application and their various choices of fasteners available, the decision is often a difficult one. In the long term, a user often tries many different screw types due to their various different combinations of features. Some users may prefer different lengths, different head sizes, different bit types used to drive the fastener, different drill and thread types. If a major screw development were to come to the market, this would further increase the choices thus potentially making it even more difficult for a user to select a preferred screw. This often results in users purchasing various different screws which then further builds personal inventory.

There are applications where there is a desire to minimize the visual profile of the hardware used to build a structure. Examples include, but are not limited to, those such as decks or fences which may be in or adjacent to common living spaces or in areas where others will notice the look of the hardware after installation. A common method used to accomplish this today includes minimizing the size of the screw head or fastening hardware that will be visible when installation is complete. This action however can reduce the holding force that the hardware is then able to apply to secure the joint. For these reasons, it is ideal to have a screw head with minimal size while also being able to apply sufficient holding force for the fastener to provide a strong joint. To further reduce the visual profile of installed hardware, it is important to have a clean installation that is free of unsightly cracks and splits which will further draw attention to the hardware.

U.S. Pat. No. 7,037,059 B2 (granted May 2, 2006) (Dicke) is for a self-tapping screw for use with composite materials. The design of this screw includes a head with a sharp edge around the perimeter of the head, a recess under the head, and two opposite hand threads. When the screw is installed, the Right-Hand thread pulls the screw into the wood, the Left-Hand screw thread pushes the displaced chips downward to prevent them from escaping out through the hole created in the surface to install the screw. The cutting edge cuts any sharp edges or chips that are pinched as the head is tightened, and the recess under the head contains any trapped chips and compresses them under the screw head as the screw is tightened.

U.S. Pat. No. 6,000,892 (granted Dec. 14, 1999) (Takasaki) is for a wood screw that is proposed for use with a material made mainly of plastic waste and wood chips. The wood screw includes a shank which has leading threads extending from the tip of the tapered portion to an intermediate point of the Straight portion and has a first lead angle and a first thread angle. Trailing threads extend from the intermediate point toward a head and have a second lead angle and a second reference cited thread angle. The first lead angle is greater than the second lead angle, and the first thread angle is smaller than the second thread angle.

U.S. Pat. No. 5,201,627 (granted Apr. 13, 1993) (Biedenbach) is a ring-shaped washer with a u-shaped profile for use especially with wood screws, has an external circumferential edge area, which is directed downwards and cuts the wood when the washer is being driven into it. At the same time the wood below the washer is compressed. This primarily serves to avoid a splitting up of the wood when screwing in the wood screw and at the same time to increase the strength of the screwed connection. U-Shaped profile is designed in a manner which creates a recessed void in the surface of the material around the device which can collect moisture or debris. When installed, the device is clearly visible and does not enhance the look of the installed hardware.

German Patent No. CH 700,825 B1 (Granted December 1978) is a disc shaped piece of hardware which has a protruding edge with teeth or tips and a central recess which receives the head of the fastener being used. In this recess is a slot-like passage opening which is provided for the shaft of the fastener being used. Device is designed to be used for fastening wooden beams or boards in a manner which requires the hardware to be inserted at an angle that is not perpendicular to the surface of the material being fastened.

U.S. Pat. No. 112,935 (granted March 1871) (Linsey) is for an improved screw design which is comprised of a slotted wood screw with a sharp lip or flange around its perimeter. This invention is intended to prevent splitting around the head of the screw as the screw is driven in without the need to countersink the screw prior to installation.

U.S. Pat. No. 1,343,209 (granted April, 1993) (Gwyer) is a novel corner fastening means for frames such as provided around the edges of panels. The Gwyer device is intended to be used when building cabinets to strengthen corners and prevent twisting strains which tend to open up corners. The Gwyer device has a particular utility when employed in top and bottom panel frames used for refrigerator casings.

U.S. Pat. No. D480,953 S (granted October, 2003) (Lee) is an ornamental design for a washer that is used to apply force the same way a pan-head screw does, but is counterbored to a flush position. The finished work is normally sanded before varnishing, creating a smooth, finished look, with the screw head and exposed washer rim being at the same level. Washer has a key role to play in renovations or external trim repair since they allow you to pull warped trim into place with long screws and then finish over it.

### SUMMARY OF THE INVENTION

A cut and compression device is provided comprising of at least one washer having at least one cutting edge and at least one compression surface wherein said washer has (a) a circular profile having a perimeter and wherein said washer has a center that is a void or a hole, and (b) wherein said cutting edge of said washer is located around or in juxtaposition to said perimeter of said washer, and wherein said compression surface is located downstream of said cutting edge.

In another embodiment of this invention, a cut and compression device is provided comprising a washer having a threaded center opening, a surface having at least one cutting edge and at least one compression surface. The internal surface includes a threaded surface that is located opposite to said cutting edge and said compression surface.

In another embodiment of this invention, a cut and compression device is provided comprising of at least one washer having an internal surface having at least one cutting edge and at least one compression surface. The washer has a receiving profile having a shape to allow the receipt of a hardware element that is a screw type which is normally driven into a workpiece with the head of the hardware element (i.e. for example a screw) resting wholly above the surface of the workpiece. In this application of the invention, the head of the hardware element may be driven wholly below the surface of the workpiece and the washer is shaped to seal the surfaces of the opening created in the workpiece as the head of the hardware element is driven past the surface of the workpiece. This application of the invention allows the user to backfill the opening left from the hardware element or to cover the opening with an additional workpiece.

These and other embodiments of this invention shall be described in more detail herein and in the drawings that show certain embodiments of this invention.

### BRIEF DESCRIPTION OF THE DRAWINGS

While various embodiments of this invention are illustrated in the drawings, the particular embodiments shown should not be construed to limit the claims. Various modifications and changes may be made without departing from the scope of the invention.

FIG. 1 is a top view of the present invention shown in its simplest form which is suitable for use with a flat head screw (i.e. an example of a hardware element), has a single cutting edge and a single compression surface. The device in this configuration is designed to be driven completely below the surface of a workpiece and is not visible after installation into the workpiece is complete.

FIG. 2 is a sectional view of the present invention as shown in FIG. 1

FIG. 3 is a sectional view of the present invention as shown in FIG. 1 and FIG. 2 when installed into a workpiece.

FIG. 4 is a close-up view of the present invention as shown in FIG. 3 shown installed into a workpiece.

FIG. 5 is a top view of a certain embodiment of the present invention. This embodiment is in a form that is suitable for use with a hardware element that is a flat head screw. The device in this configuration is designed to be driven flush with the surface, is visible from the surface after installation into the workpiece is complete, has more than one compression surface, and has an external slant (i.e. an external bevel). In this embodiment, the device will further increase the holding strength of the associated hardware element by increasing the diameter of the workpiece's material surface affected by the device. The external slant in this configuration is used to provide slight, uniform pressure in an outward direction which is used to minimize the gap around the hardware element that may open up as the material dries.

FIG. 6 is a sectional view of the present invention as shown in FIG. 5.

FIG. 7 is a sectional view of the present invention as shown in FIG. 5 and FIG. 6 shown installed into a workpiece.

FIG. 8 is a close-up view of the present invention as shown in FIG. 7. This view also shows the area where compression will occur during use (i.e. an installation into a workpiece).

FIG. 9 is a top view of the present invention that is shown in a configuration that is suitable for use with a hardware element that is a threaded bolt having a flat receiving profile. The invention in this embodiment has an internal compression surface designed to compress material within the perimeter of the cutting edge but also includes an external taper that is designed to provide slight compression of the material being fastened in an oblique direction that is generally away from the center axis of the hardware element. This design allows increased compression over using a flat washer, eliminates surface splitting around the washer, and eliminates the gap created by the cutting edge at the time of installation into a workpiece and minimizes the gap that may open as the material of the workpiece dries and shrinks.

FIG. 10 is a sectional view of the present invention as shown in FIG. 9.

FIG. 11 is a sectional view of the invention shown installed into a workpiece with suitable hardware element.

FIG. 12 is a close-up view of the present invention as shown in FIG. 11. This view also shows the area where compression will occur during use (i.e. an installation into a workpiece). FIG. 13 is a top view of the present invention that is similar to the configuration shown in FIG. 9 except this embodiment of the invention is shown with a threaded center hole. This embodiment is to allow increased compression over using a flat washer, eliminate surface splitting around washer, eliminate the gap created by the cutting edge at the time of installation, minimize the gap that may open as the material dries and shrinks and eliminate the need to apply additional hardware elements that are of a fastening element such as a threaded nut. Because the invention in this embodiment rests below the surface, it reduces the space needed to allow hardware element to protrude past the surface after installation of the device into a workpiece. Due to the shape of the device of this invention as set forth in the FIG. 13, the washer will grip the workpiece and will not spin as the threaded hardware element is tightened using the drive profile of the fastening element only. This arrangement eliminates the need to use an additional tool to hold the washer in place while drawing the fastening element tight. If removal is required, an enhancement to aid in removal may be added to the invention such as holes to accept a spanner wrench or similar gripping method to hold invention in place when loosening the threaded hardware element.

FIG. 14 is a sectional view of the present invention as shown in FIG. 13.

FIG. 15 is a view of the invention shown installed into a workpiece with a suitable hardware element.

FIG. 16 is a close-up view of the present invention as shown in FIG. 15. This view also shows the area where compression will occur during use (i.e. an installation into a workpiece).

FIG. 17 is a top view of a certain embodiment of the present invention. This embodiment is in a form that is suitable for use with a hardware element that is a construction screw. In a common application known by those person of ordinary skill in the art, a construction screw is typically driven into place using its drive profile to a depth where the head is to a depth where the head is pressing on the surface of the workpiece while the majority of the head stays above the surface. As an alternative, the construction screw may be driven below the surface however this arrangement typically tears the wood as it is driven in. The device of the present invention when applied in this configuration is designed to be inserted under the head of the construction screw and driven below the surface until the highest point of the device is flush with the surface and the screw head is wholly below the surface of the workpiece. In this instance, the washer is partially visible from the surface after installation into the workpiece is complete, has more than one compression surface, and has an external slant, and has a receiving profile that allows the head of the hardware element to be fully seated inside of the washer. In this embodiment of the invention the device will allow the hardware element to be driven wholly below the surface while compressing and covering the surfaces of the workpiece which would otherwise tear and be exposed. The external slant in this configuration is used to provide slight, uniform pressure in an outward direction which is used to minimize the gap around the hardware that may otherwise open up as the material dries. Because the invention and hardware element are installed flush to or below the surface of the workpiece in this application, it is then possible to cover the installation with another workpiece or other ornamental coverings to conceal the hardware. This is commonly a desire when building a deck or other structure where the builder prefers to wholly cover or conceal the underlying building materials with plastic or other weather resistant coverings.

FIG. 18 is a sectional view of the present invention as shown in FIG. 17.

FIG. 19 is a sectional view of the present invention as shown in FIG. 17 and FIG. 18 shown installed into a workpiece.

FIG. 20 is a close-up view of the present invention as shown in FIG. 19. This view also shows the area where compression will occur during use (i.e. an installation into a workpiece).

FIG. 21A shows an example of a hardware element that is a fastening element which is available at the present time. FIG. 21A shows a hex head structural screw.

FIG. 21B shows an example of a hardware element that is a fastening element which is available at the present time. FIG. 21B shows a flanged head structural screw.

FIG. 21C shows an example of a hardware element that is a fastening element which is available at the present time. FIG. 21C shows a flat head screw.

FIG. 21D shows an example of a hardware element that is a fastening element which is available at the present time. FIG. 21D shows a threaded hex head machine bolt.

### DETAILED DESCRIPTION OF THE INVENTION

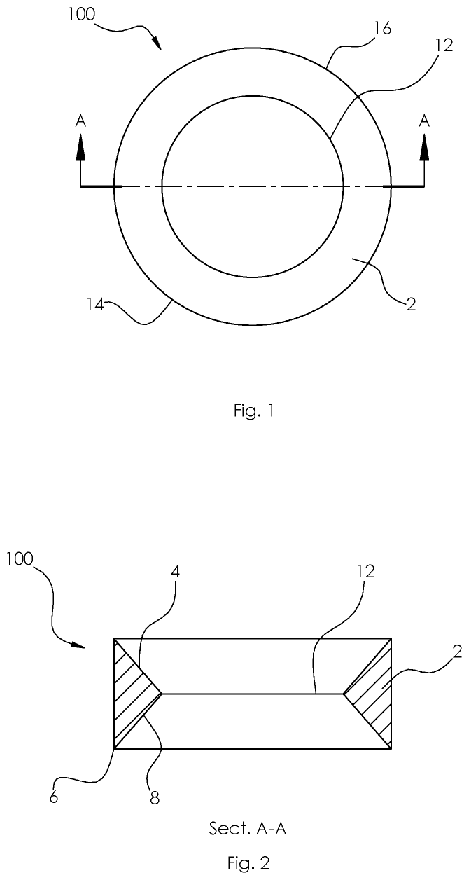

As set forth in FIGS. 1-4, this invention provides a cut and compression device 100 comprising of at least one washer 2 having at least one cutting edge 6 and at least one compression surface 8 wherein said washer 2 has (a) a circular profile 14 having a perimeter 16 and wherein said washer 2 has a center 12 that is a void or a hole, and (b) wherein said cutting edge 6 of said washer 2 is located around or in juxtaposition to said perimeter 16 of said washer 2, and wherein said compression surface 8 is located downstream of said cutting edge 6. In certain embodiments of this invention, the cut and compression device 100 includes wherein said washer 2 has a receiving profile surface 4 which is formed to match an optional hardware element 20. The hardware element 20 may be for example, but not limited to, a fastening element 21. In certain other embodiments of this invention, the cut and compression device 100 includes wherein said at least one cutting edge 6 and at least one compression surface 8 are placed in juxtaposition to a first end 26 of said hardware element 20. In certain embodiments of this invention, the cut and compression device 100 includes wherein said hardware element 20 has a head 24 attached to said first end 26 of said hardware element 20.

As used herein, the term “at least one” means one or more that one. For example, the term “at least one” may include two or more.

In another embodiment of this invention, a cut and compression device is provided comprising a nut having an internal surface having at least one cutting edge and at least one compression surface. The internal surface includes a threaded surface that is located opposite to said cutting edge and said compression surface.

In certain other embodiments of the cut and compression device of this invention, a washer is provided which prevents splitting and shredding of material, increases surface tension which results in a stronger joint, and reduces installation labor by eliminating the need to prepare the surface of material being fastened to accept the preferred hardware. Washer is designed to be used in conjunction with fastening hardware which is available to the market in the present or future. Invention is applied by inserting it between the preferred hardware and the workpiece being fastened and then installed by driving the hardware element to its final depth. When fully installed, the device may be driven partially or fully into the surface depending on configuration used. Configuration of devices will vary as needed for the application and to accommodate different types of hardware and different types of materials being fastened.

It will be understood that the cut and compression device of this invention includes a cutting edge around its perimeter and at least one compression surface that is primarily angled or shaped in an oblique manner that is angled in the direction towards the center axis of the supporting hardware such that material trapped within the perimeter of the cutting edge is compressed by the angled surface both parallel to and towards the rotational axis of the supporting hardware. This action stabilizes the area of the wood around the head and also holds the surface together as it is compressed by the force created by the supporting hardware. This design is an improvement over existing hardware because it eliminates the need for the screw head to apply a force obliquely in an outward direction away from the axis of rotation as it is tightened, which in the case of the typical flat head screw alone often causes splitting or cracking. Furthermore, the invention redirects these forces obliquely downward and towards the center axis of rotation which then densities the material and allows an increase in the amount of force that the hardware is able to exert on the surface of the material being fastened regardless of moisture level. Because force exerted on the material being fastened is redirected from outward to inward, it prevents splitting of material. Because the cutting edge applies a force that is perpendicular to the material surface and in large part does not spin with the hardware, it is able to cut the surface of the material cleanly and prevent shredding of the material surface regardless of moisture level. End result is a stronger joint with a cleaner look and minimal installation labor which performs under varying conditions.

When fastening wet pressure treated wood which will shrink excessively when dried, the invention may also have a cutting edge with an external slant which is angled away from its cutting edge perimeter and results in the cutting edge having a diameter that is slightly smaller than the outermost perimeter of the washer. When installed, the cutting edge of this design will displace a minor amount of material away from the center axis and apply slight uniform compression outwardly with the intent to compensate for and minimize the effects of shrinkage that may otherwise create a gap around the perimeter of the washer as the material dries.

The cut and compression device of this invention is designed to have many different configurations to suit different screw sizes and hardware types. The size, shape and angle of cutting edge, compression surfaces, receiving profile, and center opening size and shape can all vary to suit different types of hardware and material being fastened. In other words, the embodiment and supporting hardware type used for a given application must be matched such that the combination of hardware and device are suitable for the application.

It will be understood by those persons of ordinary skill in the art, the cut and compression device of this invention solves common issues and problems experienced when using flat head screws to fasten wood however this invention may be applied to other applications as well. For example, the device may be used in conjunction with a washer head construction screw to further increase surface tension without the need to increase the diameter of the hardware or add a flat washer with a large diameter. Devices may also be used with machine threaded hardware common to structural application where maximum force must be applied to a wood surface to secure a joint. In applications such as these, an embodiment of the device may be used to replace the flat washer in a manner that will maximize force that the hardware can exert in the wood, minimizing the diameter of the added hardware, and maximize the eye appeal of the finished result. As will be discussed later, there are additional benefits in applying this invention to applications involving flanged hex head construction screws or flanged head structural screws.

The invention as disclosed herein, is intended to be used separate from and in addition to the fastening element. This benefit allows the invention to be applied for use with any compatible hardware of preference without requiring the user to duplicate related fasteners to configurations with and without device. Design allows for an economic design that may be applied by the user as they see fit without the need to purchase a large number of additional hardware elements. Users can purchase their preferred fastener design (i.e. a fastening element) and add the device of this invention as needed to suit their current needs. For example, some users prefer to use a screw with a Phillips Head (an example of a fastening element) while others prefer to use a screw type with a Torx style fastener (another example of a fastening element). Since the device is designed to function separate from the hardware element and embodiments of this invention as described herein shall work with groups of different hardware element styles, users have the option to use any standard fastening element of their preference which is compatible with the suitable embodiment of the invention. The result is that the user is only required to purchase the preferred sizes of hardware elements of their choice and the configurations/embodiments of the invention that they will require. Users can apply the invention when they see fit to use with their preferred hardware element or simply use their preferred hardware element without the invention if their application does not require the added benefits which the invention provides.

As separate embodiments, the device of this invention may also be created as a separate part and then fused to the preferred hardware element or fastening element in some way to promote economical manufacturing methods while also making the device easier to install into a workpiece. Furthermore, invention may be fused to the hardware element in a manner that promotes the invention to break away from the hardware element such that when tightened, the invention will stay relatively stationary while the hardware element is a fastening element that spins and draws the fastening element and device into the material of the workpiece being fastened. For this reason, the invention may be combined with the fastening element and sold as a unit with the preferred fastening element or sold separately and combined by the end user at installation of the device into the workpiece.

After the invention is driven into the surface of the material of the workpiece being fastened, if the user desires to remove the hardware element to break the joint, the fastening element may be removed and the invention will stay somewhat stationary though depending on the characteristics of the material being fastened, the device may push up and away from the surface of the workpiece a bit (for example but not limited to 1-5 millimeters). If the user desires to remove the invention, they can do so by using a tool suitable for removal which is capable of gripping the invention and pulling it in a direction that is parallel to the axis of the center opening.

Due to the distinctly improved forces that the hardware may exert on the material being fastened when the invention is applied to the application in accordance with the intended design of each embodiment, the user can accomplish a stronger joint with minimal hardware diameter. Furthermore, where the invention breaks the surface of the material being fastened, the perimeter of the opening will be cut in a manner that maximizes compression, while minimizes splitting and shredding of the surface.

In certain embodiments of this invention, a ring or other shaped washer designed primarily to fasten two or more pieces of wood however washer may be used with other materials as well such as composites and plastics which are suitable for the application. Washer has at least one cutting edge and at least one compression surface. Cutting edge is primarily angled inward such that it will cut a neatly shaped hole through the surface of the material, reduce splitting around the hardware, compress material within the perimeter of the cutting edge towards the center axis, and increase surface tension beyond what would typically be achieved without the device. Because the amount of surface tension that a piece of hardware element is able to exert on a workpiece is determined by the surface area of the hardware element applied in an efficient manner, ie slanted inwards, the slanted compression surface allows the cut and compression device to exert increased pressure in a reduced diameter space. Washer is designed to be used with additional hardware element which is threaded and is common to the industry. Washer may be used with any type of fastening element which is suitable for the application. Fastening element examples include but are not limited to hex head structural screws, flanged head structural screws, flat head screws, machine bolts, threaded nuts or similar types of hardware. When installed, the washer is drawn into the material being fastened while tightening the associated hardware element in its typical manner by those persons of ordinary skill in the art. To install, the device penetrates partially or fully into the surface of the material being fastened; however, the depth in which the device penetrates will vary by the application. For example, when used in conjunction with a flat head screw, the device is driven flush with the surface or below the surface however when used with a machine threaded fastener such as a bolt, fastener may be drawn partially or wholly into the surface such that the washer is above, flush to, or below the surface of the material being fastened. Washer is typically constructed of steel or other suitable metal, which is harder than the material being fastened, however other materials such as hard plastics may also be used if their material properties are suitable for the application.

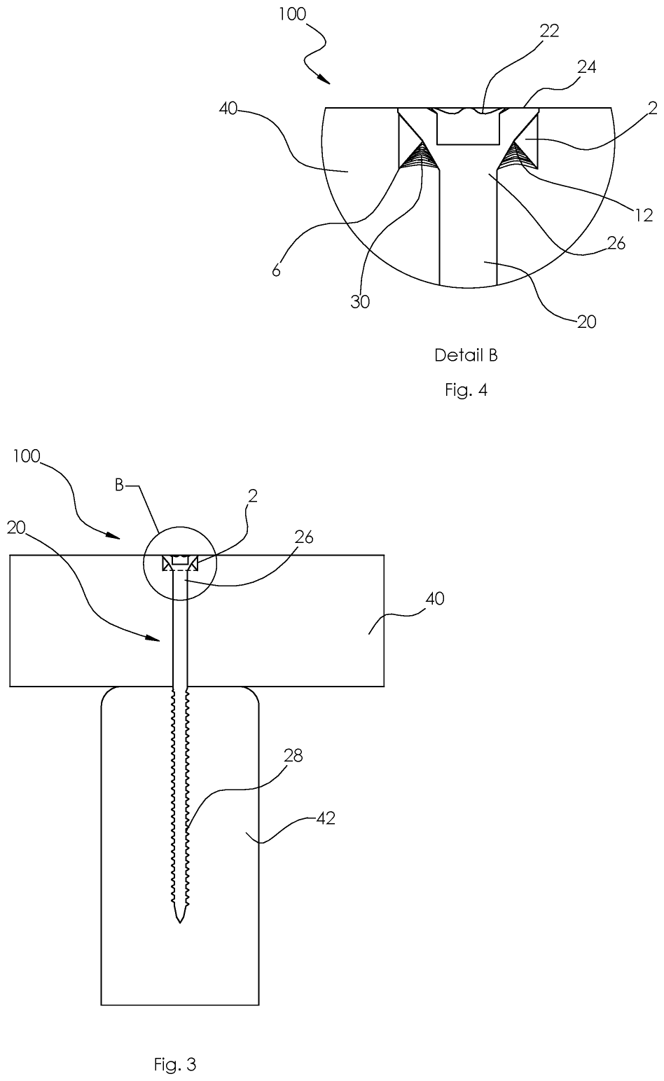

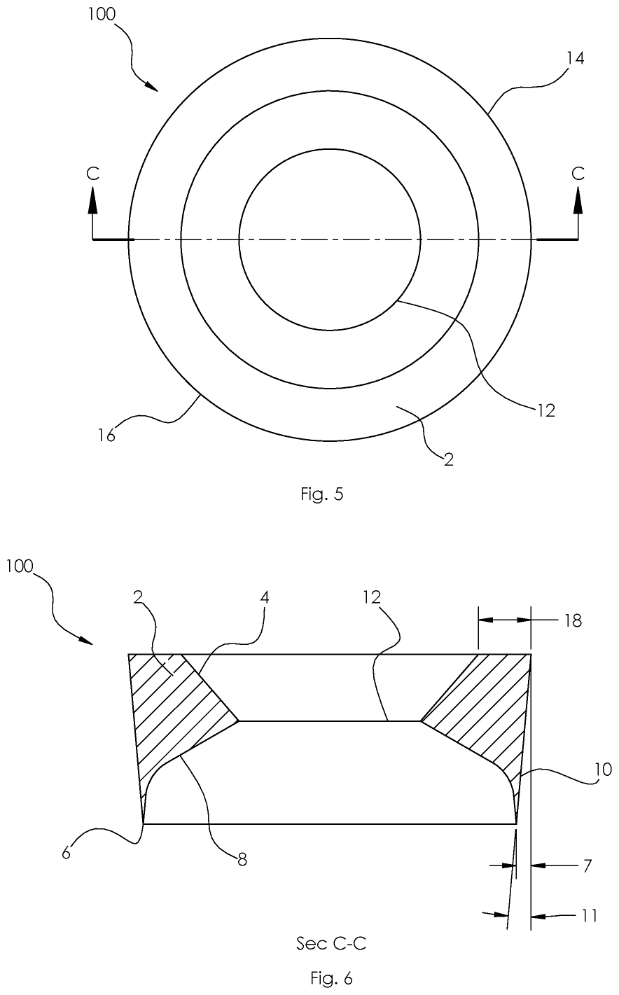

A certain embodiment of this invention is set forth in FIGS. 1-4. As shown in FIG. 1 and FIG. 2, the washer 2 has a circular profile 14, with a center opening 12 and a cutting edge 6 around its perimeter 16, and a downstream compression surface 8. Washer 2 has a receiving profile surface 4 which is formed to match the hardware element 20 being used. As shown in FIG. 3 and FIG. 4, the washer 2 as seen in FIG. 1 and FIG. 2 is shown installed in a typical manner. Because the washer 2 may be applied in numerous different applications, the example shown is intended to represent a first workpiece 40 being fastened to a secondary workpiece 42 using a common hardware element 20 that in this embodiment is represented as a flat head screw. First end 26 of said hardware element 20 includes a head 24 which has a drive profile 22 and a second end 28 of said hardware element 20 which is threaded and is used to drive the hardware element 20 into place as it is rotated during installation to drive the washer 2 into place. When washer 2 is driven into place by said hardware element 20, the perimeter 16 of the cutting edge 6 cuts the surface of the first workpiece 40 and compresses the material 30 within the perimeter 16 of the cutting edge 6. Those persons of ordinary skill in the art will understand that the physical dimensions of the configuration of the invention 100 may vary to suit the hardware of choice being used with the washer 2 and the properties of the material being fastened.

Certain additional embodiments of this invention are described in FIGS. 5-8. As shown in FIG. 5 and FIG. 6, a cut and compression device 100 is set forth comprising a washer 2 that has a circular profile 14, with a center opening 12 and a cutting edge 6 around a perimeter 16 of said washer 2, an internal compression surface 8 and an external compression surface 10.

As shown in FIG. 5-8, this particular embodiment includes a washer 2 that has a receiving profile 4 which is shaped to receive a fastening element 21. To install, the washer 2 is driven into place using a fastening element 21. It will be appreciated that the fastening element 21 is a certain type of hardware element 20. Thus, the fastening element 21 has a first end 26 and a second end 28. In FIGS. 5-8, the first end 26 of said fastening element 21 includes a head 24 which has a drive profile 22. Second end 28 of said fastening element 21 includes a thread. To install, said fastening element 21 is rotated via drive profile 22 as the thread on the second end 28 draws the washer 2 into the first workpiece 40 until the washer 2 is driven to the desired depth. As an additional enhancement, washer 2 includes a cutting edge 6 that has an external bevel 11 which offsets 7 the cutting edge 6 to have a diameter that is less than the outermost edge of the washer 2 which when driven into the first workpiece 40 creates an external compression surface 10. Due to the shape of the cutting edge 6 and the compression surfaces 8 and 10, the cutting angle is steeper, and thus allows the cutting edge 6 to pierce the surface of the first workpiece 40 more effectively. The compression surface 8 of the washer 2 allows the material of the workpiece within the perimeter 16 of the cutting edge 6 to be compressed 30 in a more uniform manner which further increases surface tension. Furthermore, the external compression surface 10 applies an outward force on the first workpiece 40 which increases the strength of the joint and minimizes the possibility of a gap opening up around the perimeter 16 of the washer 2 as the first workpiece 40 may shrink and move after installation.

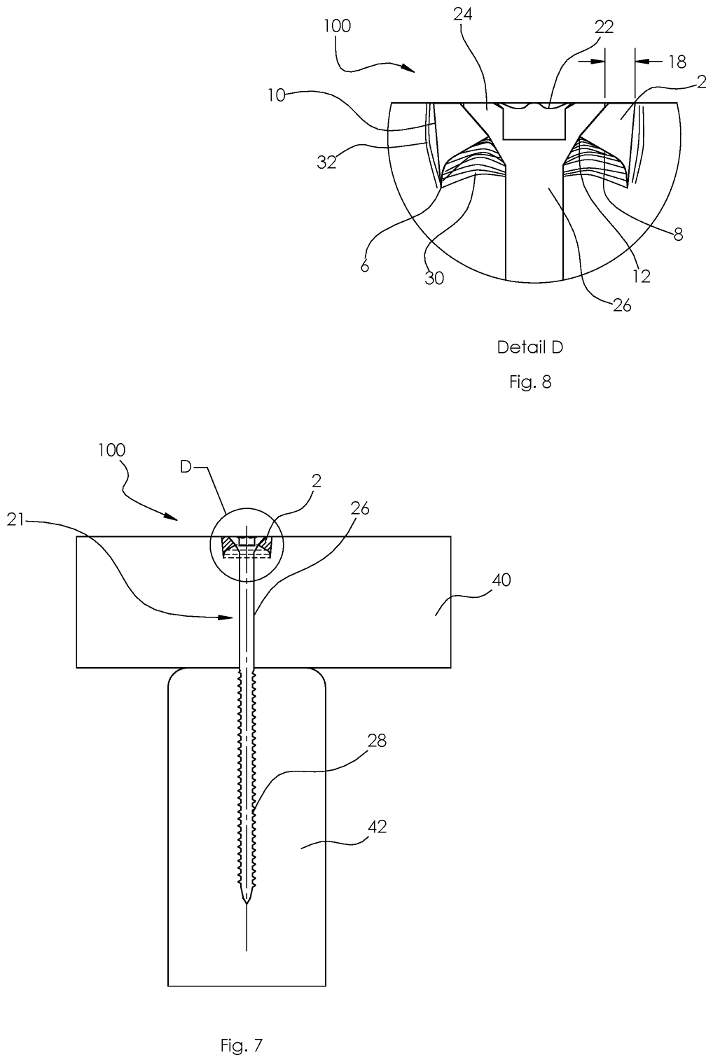

As shown in FIG. 7 and FIG. 8, the washer 2 as set forth in FIG. 5 and FIG. 6 is installed in a typical manner. Because the washer 2 may be applied in numerous different applications, the example shown is intended to represent a first workpiece 40 being fastened to a second workpiece 42 using a fastening element 21 which in this case is shown as a flat head screw having a drive profile 22 incorporated into a head of hardware element 24 which is part of a first end of fastening element 26 and then driven into place by the second end of fastening element 28. In this embodiment, the larger diameter washer is designed to increase surface tension beyond what would be accomplished using a reduced diameter washer 2. To maximize surface tension, the diameter of the device may be increased beyond the head of the hardware element 20 while also minimizing the diameter needed to achieve the comparable tension that could be matched using alternative hardware element available on the market today. In this application, a minimal portion of the device would be visible from the surface 18. Because the washer 2 in this case is visible from the surface 18, as a further enhancement, the washer may be colored to match the first workpiece 40 such that it will be less visible after installation. The external compression surface 10 is used to compress material 32 outside the perimeter 16 of the cutting edge 6. which increases the strength of the joint and minimizes the possibility of a gap opening up around the perimeter 16 of the washer 2 as the first workpiece 40 may shrink and move after installation.

When the washer 2 is driven into place, material within the perimeter 16 of cutting edge 6 is compressed 30. It goes without saying that the physical dimensions of the configuration as shown will vary to suit the hardware of choice being used with the washer 2.

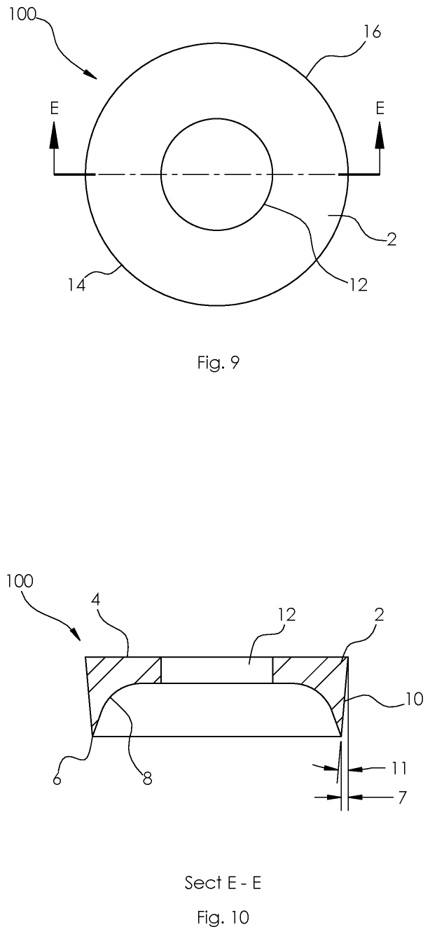

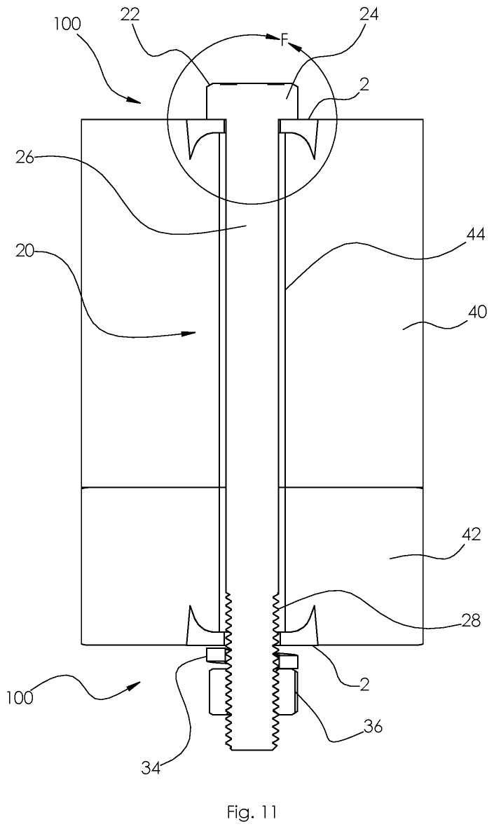

Certain additional embodiments of this invention are set forth in FIGS. 9-12. As shown in FIGS. 9 and 10, the washer 2 has a circular profile 14, with a center opening 12 and a cutting edge 6 around its perimeter 16, an internal compression surface 8, and an external compression surface 10. Washer 2 has a flat receiving profile 4. Washer 2 includes an external bevel 11 which creates a cutting edge offset 7.

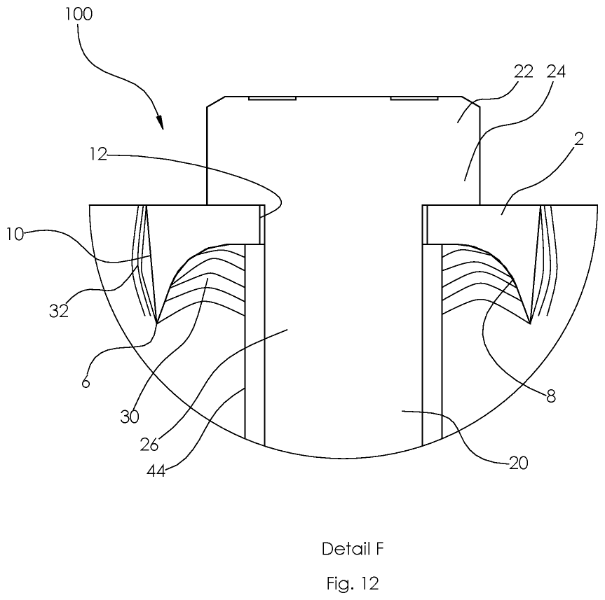

As shown in FIG. 11 and FIG. 12, the washer 2 as seen in FIG. 9 and FIG. 10 is shown installed with hardware element 20 having a first end 26 and also at the second end 28. At the first end 26, the washer 2 is installed between the head 24 of hardware element 20 and first workpiece 40. On the second end 28 of hardware element 20, the washer 2 is positioned between a lock washer 34 and the second workpiece 42 and is drawn into place using a threaded nut 36. Because the washer may be applied in numerous different applications, the example shown is intended to represent a first workpiece 40 being fastened to a second workpiece 42 using a hardware element 20 which is represented in this example as a hex head bolt which to install requires a center clearance hole 44 to exist through workpieces 40 and 42 prior to inserting the hardware element 20 and then drawing it tight using a hex nut 36 and holding it tight using a lock washer 34. On first end 26 of hardware element 20, the head 24 of the hardware element 20 is tight against the washer 2 which was drawn flush to surface of first workpiece 40. On the second end 28 of said hardware element 20, a threaded nut 36 is tightened against a common lock washer 34 which then tightens against the washer 2 to draw the washer 2 into second workpiece 42 until it is flush to the surface of said fastening element 20. In both instances, the washer 2 takes the place of a common flat washer; however in this application, the washers 2 are able to apply a greater force on the workpiece 40, 42 due to the increased surface area of the washer 2 compression surface 8, 10 while keeping the diameter of the washer 2 to a minimum. Furthermore, the cutting edge 6 around the perimeter 16 provides increased area of the compression surface 8 which permits this greater force to be applied to the workpieces 40 and 42 and thus create a stronger joint. In both instances, the washers 2 and 2 help the head 24 of said fastening element 21 and nut 36 to apply substantially greater force on the material and thus create a stronger joint. As an additional enhancement, an external compression surface may be added 10 which allows material 32 located outside the perimeter of the cutting edge 6 to be compressed uniformly in a manner which will minimize the gap between the workpieces 40 & 42 and the external compression surface 10 of washer 2. In this particular instance, installation of the machine bolt requires that a hole 44 be placed through the workpieces 40 and 42 prior to insertion of the fastening element 20. In this example, the washer 2 is driven flush to the surface of workpieces 40 and 42. If the user desires to do so, the washer may be driven ever farther into the material until their desired bolt tension is reached.

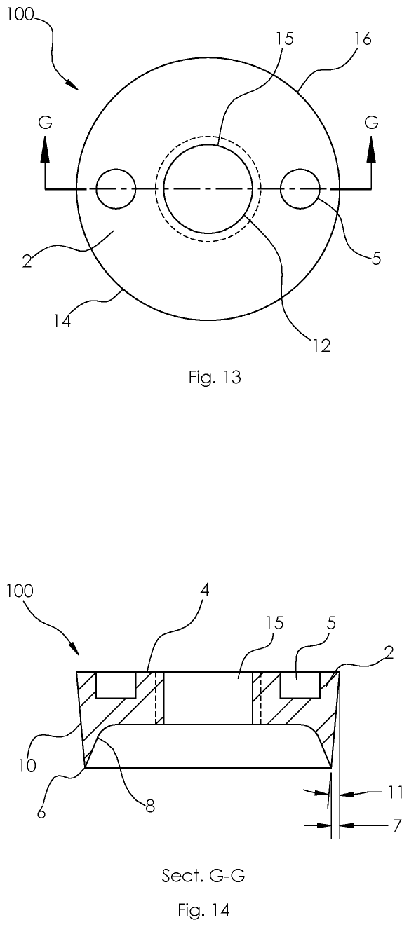

Certain additional embodiments of this invention are set forth in FIGS. 13-16. As shown in FIGS. 13 and 14, the washer 2 has a circular profile 14, with a center opening 12 and a cutting edge 6 around its perimeter 16, an internal compression surface 8, and an external compression surface 10. Washer 2 has a flat receiving profile 4 and includes an external bevel 11 which creates a cutting edge offset 7. As additional features, washer 2 is shown with a center opening 12 which is threaded 15 and also includes two pin holes 5 to accept a spanner wrench.

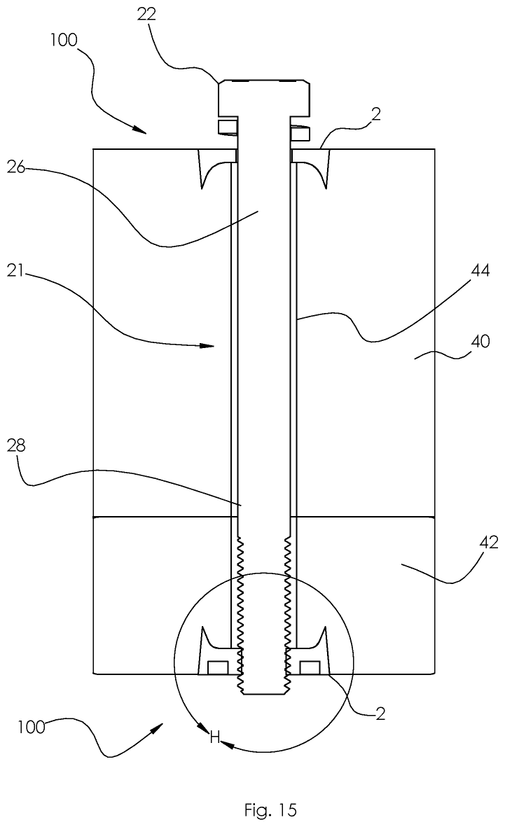

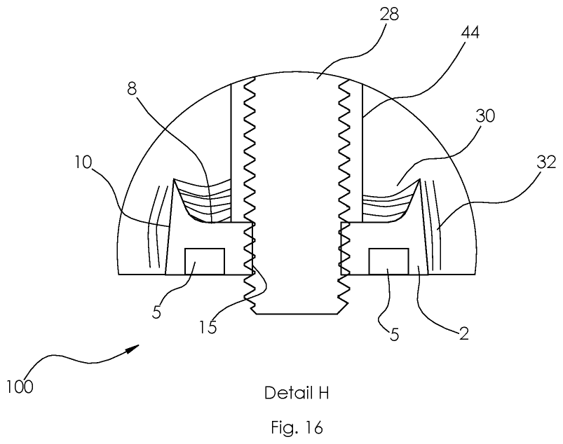

As shown in FIG. 15 and FIG. 16, the washer 2 as seen in FIG. 13 and FIG. 14 is shown installed at first end 26 of hardware element 20 in virtually the same manner as shown in FIG. 5-8. On second end 28 of hardware element 20, washer is shown threaded directly onto the hardware element 20 in a manner which removes the need for an additional threaded nut 36 to secure the washer 2. In this embodiment, the hardware element 20 which protrudes beyond the surface of the second workpiece is kept to a minimal profile and does not require an additional tool to hold the washer 2 in place as the hardware element 20 is tightened to draw the workpieces 40 and 42 together. If the user were to have a desire to remove the hardware element 20, it may be necessary to hold the washer 2 in place to prevent it from rotating with the fastening element 21. To allow the user to grip the washer 2, holes 5 may be added to accept a spanner wrench or another suitable method may be used to hold the washer 2 in place as the fastening element 21 is rotated for removal.

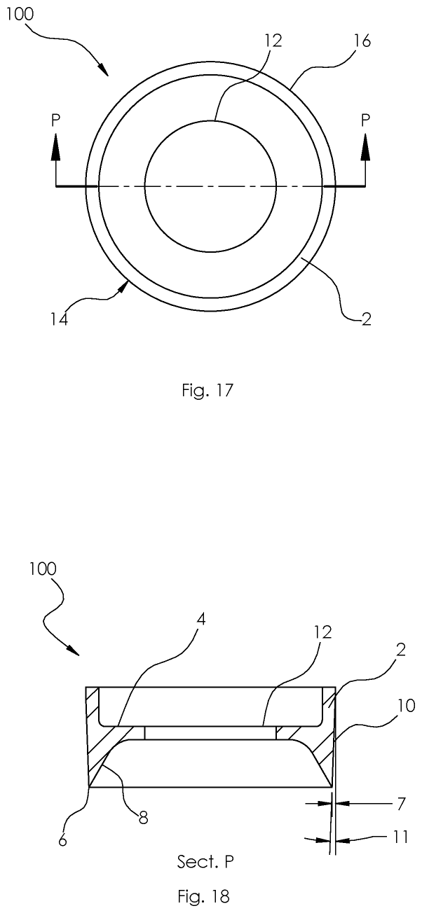

Certain additional embodiments of this invention are set forth in FIGS. 17-20. As shown in FIGS. 17 and 18, the washer 2 has a circular profile 14, with a center opening 12 and a cutting edge 6 around its perimeter 16, an internal compression surface 8, and an external compression surface 10. Washer 2 has a receiving profile 4 which is piloted to allow the head 24 of the fastening element 21 to be sunk below the surface of the first workpiece 40 and includes an external bevel 11 which creates a cutting edge offset 7.

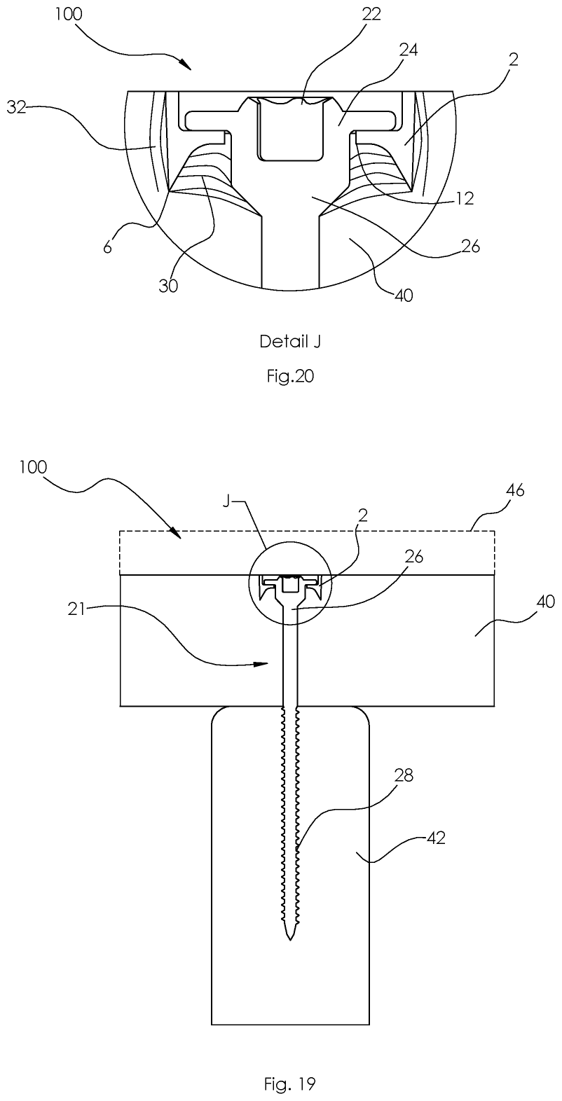

As shown in FIG. 19 and FIG. 20, the washer 2 as seen in FIG. 17-18 is shown installed at first end 26 of fastening element 21. When fastening element 21 is driven into place, the head 24 of fastening element 21 is driven into the first workpiece 40 until the head 24 of said fastening element 21 is wholly below the surface of the first workpiece and the washer 2 is flush with the surface of first workpiece 40. Benefit of this arrangement allows the complete hardware element to be covered with an additional workpiece 46 to completely hide the hardware element as is common when covering a structure with PVC sheeting or other suitable covering.

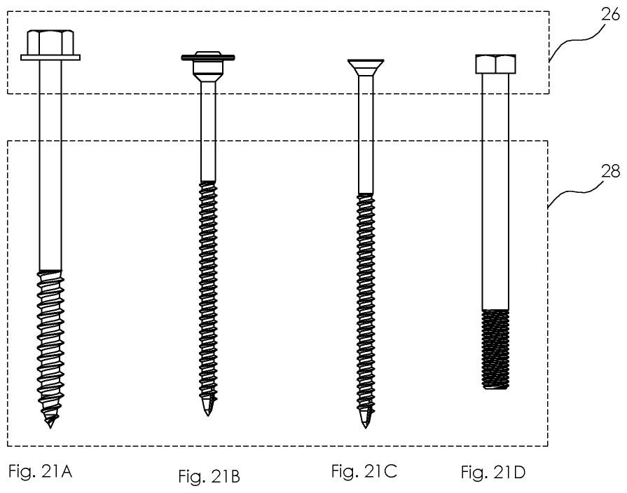

Supporting FIG. 21A, FIG. 21B, FIG. 21C and FIG. 21D show some examples of potential fastening elements as referred to in previous embodiments. FIG. 21A refers to a hex head structural screw. FIG. 21B refers to a flanged head structural screw, 21C refers to a flat head screw, 21D refers to a threaded hex head machine bolt.

It will be understood by those persons of ordinary skill in the art that the dimensions and configuration of the cut and compression device of this invention may vary to determine cutting action and the amount of compression needed for a particular use and application. Such dimensions and configurations needed for a specific use and application is driven by the intentions of the user.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A cut and compression device comprising:
at least one washer having at least one cutting edge and at least one compression surface wherein said washer has (a) a circular profile having a perimeter and wherein said washer has a center opening that is a void or a hole, and (b) wherein said cutting edge of said washer is located around or in juxtaposition to said perimeter of said washer, and wherein said compression surface is located downstream of said cutting edge.

2. The cut and compression device of claim 1 including wherein said washer has a receiving profile surface which is formed to match a hardware element.

3. The cut and compression device of claim 2 including wherein said hardware element is a fastening element,

4. The cut and compression device of claim 3 including wherein said at least one cutting edge and at least one compression surface are placed in juxtaposition to a first end of said fastening element.

5. The cut and compression device of claim 4 including wherein said fastening element has a head attached to said first end of said fastening element.

6. A cut and compression device comprising: a nut having an internal surface having at least one cutting edge and at least one compression surface.

7. The cut and compression device of claim 6 including wherein said internal surface includes a threaded surface that is located opposite to said cutting edge and said compression surface.

8. A cut and compression device comprising:
at least one washer having at least one cutting edge and at least one compression surface wherein said washer has (a) a circular profile having a perimeter and wherein said washer has a center opening that is a void or a hole, and (b) wherein said cutting edge of said washer is located around or in juxtaposition to said perimeter of said washer, and wherein said compression surface is located downstream of said cutting edge, and wherein said cutting edge of said washer has an external bevel which offsets said cutting edge of said washer to have a diameter that is less than the outermost edge of said washer.

9. The cut and compression device of claim 8 including wherein said washer has a receiving profile surface which is formed to match a hardware element.

10. The cut and compression device of claim 9 including wherein said hardware element is a fastening element,

11. The cut and compression device of claim 10 including wherein said at least one cutting edge and at least one compression surface are placed in juxtaposition to a first end of said fastening element.

12. The cut and compression device of claim 11 including wherein said fastening element has a head attached to said first end of said fastening element.
